(19) United States
(12) Patent Application Publication
(10) Pub. No.: US 2025/0342555 A1
(43) Pub. Date: Nov. 6, 2025

(54) HARDWARE-AWARE ATTENTION MECHANISM WITH DYNAMIC WORKLOAD DISTRIBUTION FOR TRANSFORMER MODELS

(71) Applicant: Microsoft Technology Licensing, LLC, Redmond, WA (US)

(72) Inventors: Vedula Venkata Srikant BHARADWAJ, Redmond, WA (US); Saravanakumar RAJMOHAN, Redmond, WA (US); Victor Jonas RÜHLE, Cambridge (GB); Rya SANOVAR, Hyderabad (IN); Renee Marie ST AMANT, Kirkland, WA (US)

(21) Appl. No.: 18/984,216

(22) Filed: Dec. 17, 2024

(30) Foreign Application Priority Data
May 6, 2024 (IN) 202411035684

(51) Int. Cl. G06T 1/20

(52) U.S. Cl. CPC G06T 1/20

(57) ABSTRACT

A technique for optimizing attention mechanism computations in transformer-based language models improves computational efficiency during both prefill and decode phases. The approach unequally partitions attention operations across multiple streaming multiprocessors of a hardware processing unit (e.g., such as a graphics processing unit, or GPU) to maximize hardware utilization. By leveraging the associative property of online softmax calculation as a reduction operation and employing stream-K style decomposition, the technique enables parallelization across all modes of the attention matrix, including the context length dimension. This allows for efficient distribution of computational workload across available GPU resources while ensuring equal total work allocation. The approach delivers significant speedup over existing methods, particularly for long context lengths, by maintaining near 100% GPU occupancy through optimal workload distribution and single-kernel execution.

### RELATED APPLICATIONS

This application claims the benefit under 35 U.S.C. § 119 (a) of Indian Patent Application number 202411035684, filed May 6, 2024, entitled ‘METHOD FOR SCALABLE ATTENTION EXECUTION MECHANISM OF PARALLEL ARCHITECTURES,’ which is hereby incorporated by reference in its entirety.

### TECHNICAL FIELD

The present disclosure relates generally to optimizing attention mechanism computations in transformer-based language models, and more particularly to methods for efficient execution of attention operations on parallel computing architectures like graphics processing units (GPUs). Specifically, the disclosure describes techniques for unequally partitioning attention operations across multiple streaming multiprocessors to maximize hardware utilization and computational efficiency during both prefill and decode phases of model inference. The disclosure further relates to systems and methods for scalable attention execution that enable parallelization across all modes of the attention matrix, including the context length dimension, while ensuring equal total work allocation across available compute resources. The technical field encompasses machine learning, artificial intelligence, and specifically the optimization of attention mechanisms in large language models to address challenges of long context lengths and hardware resource utilization through stream-K style decomposition and efficient workload distribution techniques.

### BACKGROUND

Transformer-based language models have revolutionized the field of natural language processing and found applications across diverse domains. These powerful models, fueled by massive amounts of data and sophisticated architectures, have become indispensable tools for tasks such as machine translation, question answering, text generation, and sentiment analysis. At the core of the transformer architecture is the self-attention mechanism, which enables the model to weigh the relative importance of different words or tokens in a sequence when processing language.

As state-of-the-art models continue to grow in size and capability, they increasingly support greater context lengths, with some production models now handling hundreds of thousands of tokens. This expansion of context length capabilities can significantly improve a model's utility by allowing for an increasingly rich context, which is particularly beneficial in applications involving numerous or long documents. The execution of these models relies heavily on graphics processing units (GPUs) and other artificial intelligence (AI) accelerators, which provide the parallel computing capabilities needed to process large amounts of data efficiently.

### BRIEF DESCRIPTION OF THE DRAWINGS

Embodiments are illustrated by way of example and not limitation in the figures of the accompanying drawings, in which:

FIG. 1 is a diagram comparing streaming multiprocessor (SM) occupancy and latency between conventional FlashAttention-2, FlashAttention-2 with fixed-split implementations, and improved techniques consistent with some embodiments.

FIG. 2 is a diagram illustrating conventional iterative update of output in FlashAttention-2 with three iterations, demonstrating key technical limitations with the conventional approach.

FIG. 3 is a graph showing timeshare comparison between prefill and decode stages for different ratios of prompt tokens to output tokens, consistent with some embodiments.

FIG. 4 is a graph comparing SM occupancy percentages between different attention implementations across varying numbers of attention heads and batch sizes, where techniques consistent with some embodiments show improved occupancy over prior art techniques.

FIG. 5 is a diagram illustrating decomposition strategy techniques consistent with some embodiments, showing independent computation of un-scaled outputs and subsequent re-scaling.

FIG. 6 is a diagram showing linear mapping of computational tiles across cooperative thread arrays (CTAs) in accordance with some embodiments.

FIG. 7 through FIG. 10 depict bar charts illustrating various performance

FIG. 11 is a block diagram illustrating an example computing device architecture suitable for implementing techniques consistent with some embodiments.

### DETAILED DESCRIPTION

Described herein are methods and systems for optimizing attention mechanism computations in transformer-based language models by efficiently distributing computational workload across streaming multiprocessors of hardware processing units (e.g., such as graphics processing units, or GPUs). The techniques leverage the associative property of online softmax calculations to enable parallelization across all modes of the attention matrix, including the context length dimension. By unequally partitioning attention operations into variable-sized computational units and distributing them optimally across available GPU resources, the methods achieve near 100% hardware utilization and significant speedup in both prefill and decode phases of model inference. In the following description, for purposes of explanation, numerous specific details are set forth to provide a thorough understanding of the various aspects of different embodiments. It will be evident, however, to one skilled in the art that the described techniques may be practiced without all of these specific details.

Transformer-based language models have revolutionized the field of natural language processing and found applications across diverse domains. These powerful models, fueled by massive amounts of data and sophisticated architectures, have become indispensable tools for tasks such as machine translation, question answering, text generation, and sentiment analysis, amongst others.

The core of the transformer architecture is the self-attention mechanism, which faces significant technical challenges in its execution. Specifically, the self-attention mechanism suffers from two critical performance bottlenecks: (1) slow execution speed due to computational complexity, and (2) excessive memory requirements, particularly when processing long sequences of tokens. A standard implementation of self-attention exhibits quadratic time and memory complexity with respect to total sequence length, creating severe scalability limitations as model sizes and supported context lengths increase. These technical challenges have become increasingly problematic as state-of-the-art models push toward supporting greater context lengths, with some production models now needing to process hundreds of thousands of tokens. While longer context lengths enable improved model utility through richer contextual understanding, which benefits applications requiring analysis of lengthy documents, the computational demands of processing such extended sequences pose fundamental engineering challenges that must be addressed to enable practical deployment.

To mitigate these technical, scalability challenges with LLMs, mechanisms like FlashAttention and FlashAttention-2 have been developed. FlashAttention brings IO-awareness to optimize computation in the attention mechanism in a way that reduces slow reads and writes to and from GPU high bandwidth memory via incrementally computing the softmax computation in SRAM, also known as tiling. This allows for parallelization over batch size and number of heads. FlashAttention-2 builds on FlashAttention to further optimize the attention mechanism by increasing non-matrix multiply compute operations while reducing memory operations (such as loads and stores) to maximize GPU throughput, and it additionally enables parallelization across input sequence length (or, query length) as well. While these optimizations provide significant improvements—for example, FlashAttention-2 realized 2× speedup over FlashAttention—these mechanisms only provide performance benefits for a subset of problem sizes (e.g., sequence length, batch size, and number of heads) because they overlook the distinct behavior of the attention mechanism during the decode phase versus the prefill-phase in decoder-only transformer models.

In decoder-only transformer models, the inference process for a single request involves multiple forward passes of the model where output tokens are generated sequentially. This inference procedure inherently comprises two distinct computational phases due to the practice of reusing (i.e., caching) the key-value tensors of the attention mechanism of the previously computed tokens. The first phase is the “prompt computation phase” (sometimes known as the “prefill phase”) where all tokens from the input prompt undergo parallel forward passes through the model to generate the first output token. This phase is computationally intensive and demands high floating-point operations per second (FLOPs). Following the prompt computation, the “decode phase” (sometimes known as the “token-generation phase”) begins in an auto-regressive manner. Each subsequent token is produced based on the forward pass of the preceding token and the cached context from previous tokens in the sequence. With the push towards longer context lengths, this cached context can be long, exceeding more than hundreds of thousands of tokens in length. Despite state-of-the-art batching techniques and attention partitioning mechanisms, the sequential processing of this long context length makes the decode phase slow, bound by memory bandwidth and capacity. Importantly, even when the prompt size is significantly larger than the number of output tokens, the majority of the overall processing time is consumed by the decode or token-generation phase.

During the decode phase of language model inference, conventional FlashAttention-2 implementations provide limited parallelization capabilities, operating primarily along two dimensions: the number of attention heads and batch size. While FlashAttention-2 with fixed-split partitioning attempts to improve parallelization by additionally enabling computation along the context length dimension, this approach introduces significant hardware underutilization. Specifically, the fixed-split partitioning strategy suffers from two key drawbacks. First, it requires launching multiple separate kernels—an initial computation kernel followed by an additional reduction kernel-which introduces kernel launch overhead that impacts overall performance. Second, the fixed equal-sized partitioning of work leads to load balancing inefficiencies, where available compute resources may be left unused or underutilized.

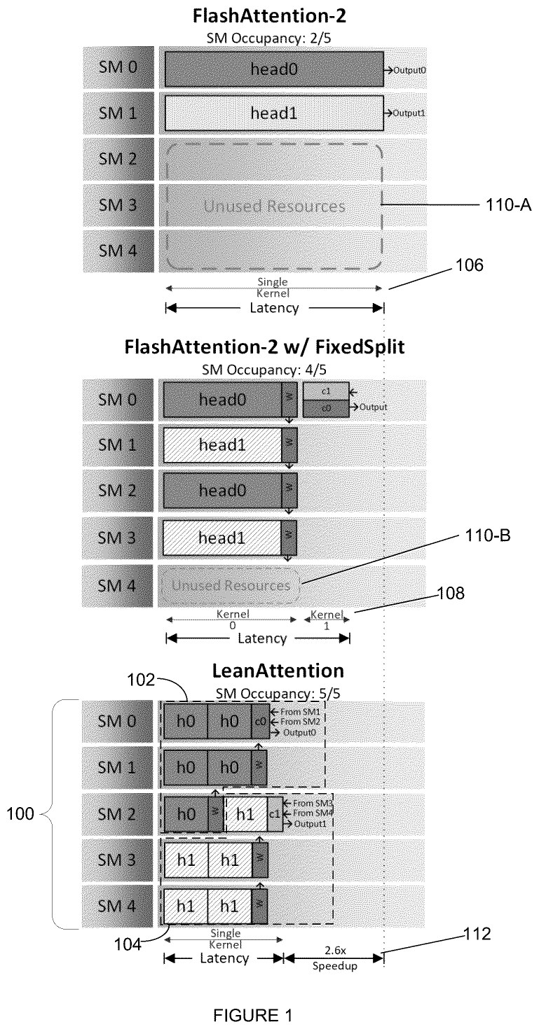

As illustrated in FIG. 1, FlashAttention-2 with fixed-split achieves only 80% streaming multiprocessor occupancy while requiring two separate kernel launches. This suboptimal resource utilization stems from the rigid equal-sized work partitioning that does not adapt to the actual computational requirements or available hardware resources. The reduction overhead also increases with problem size, further limiting scalability for processing longer sequences. These limitations become particularly pronounced when processing long context sequences during the decode phase, where efficient parallelization across all available compute resources is crucial for maintaining low latency. The fixed-split approach's inability to achieve optimal hardware utilization and its growing reduction overhead with sequence length make it unsuitable for modern language models that must process increasingly long contexts while maintaining responsive performance.

To address these limitations, an improved technique, referred to herein as “LeanAttention”, provides optimized attention mechanism computations in transformer-based language models. LeanAttention unequally partitions computational work across streaming multiprocessors to achieve maximum hardware utilization and reduced latency, particularly during the decode phase where conventional approaches suffer from inefficient resource usage.

As illustrated in FIG. 1, LeanAttention achieves optimal hardware utilization through unequal partitioning of computational work across streaming multiprocessors (SMs) 100. The bottom portion of FIG. 1 demonstrates LeanAttention's implementation, where computational work is distributed across attention heads (h0 102 and h1 104) and streaming multiprocessors 100 to achieve 100% SM occupancy. Data flow arrows indicate efficient combination of partial results. This represents a significant improvement over conventional approaches shown in the top and middle portions of FIG. 1, where FlashAttention-2 achieves only 40% SM occupancy with a single kernel launch 106, and FlashAttention-2 with fixed-split reaches 80% occupancy while requiring multiple kernel launches 108.

The technical advances of LeanAttention encompass several key innovations. Through analysis of conventional attention execution approaches during the decode phase, LeanAttention identifies critical inefficiencies in GPU resource utilization that lead to significant underutilization of streaming multiprocessors. As shown in FIG. 1, conventional approaches either leave multiple SMs unused (demonstrated in unused resources area 110-A and 110-B) or require inefficient multiple kernel launches 108, while LeanAttention enables improved parallelization and workload distribution.

LeanAttention introduces a novel reduction-based approach by leveraging the associative property of softmax operations. This allows the re-scaling of un-scaled attention outputs to be extracted from the main computation loop and treated as an independent reduction operation. This mathematical insight, visualized by the data flow arrows in FIG. 1, enables flexible partitioning of work across GPU resources while maintaining computational accuracy in a single kernel execution.

LeanAttention implements an adaptive partitioning scheme that ensures balanced computational loads across all available hardware resources. Unlike the fixed-split approach shown in the middle portion of FIG. 1, which divides work into equal portions and leaves resources unused (area 110-B), LeanAttention's stream-K style partitioning strategy intelligently distributes variable-sized work units to each streaming multiprocessor. This approach maximizes GPU occupancy regardless of problem size or hardware configuration, as demonstrated by the balanced workload distribution in the bottom portion of FIG. 1.

Finally, LeanAttention introduces a hardware-aware attention partitioning mechanism that efficiently maps computational work to available GPU resources. This mechanism closely aligns attention computations with modern GPU architectures by considering both compute and memory hierarchies during workload distribution. As evidenced by the speedup indicator 112 showing 2.6× improvement, this approach optimizes performance for both decode and prefill phases of transformer model inference, delivering consistent speedups across a wide range of operational scenarios.

### BACKGROUND

To provide context for understanding the improved techniques described herein, before describing the details of the improved technique (e.g., LeanAttention), the following background information describes conventional attention mechanisms in transformer-based language models.

### Standard Attention

The standard attention mechanism processes input data having several key dimensions: batch size B, representing the number of parallel requests being processed, query sequence length Nq, representing the number of input tokens, key/value sequence length Nk (also known as context length), representing the context being attended to, and hidden dimension D representing the size of the token embeddings. In typical implementations, the attention computation is split into multiple heads, where the hidden dimension D is divided into h equal parts, with each head independently computing attention over its portion of size d=D/h.

A key distinction exists between the prefill and decode phases of transformer model execution. In the prefill phase, such as in decoder-only transformers, the query length equals the context length (Nq=Nk=N). However, during the decode phase, the context length grows incrementally with each generated token, while the query length remains fixed at one token—the most recently generated output. This fundamental difference in computational pattern has important implications for optimizing attention mechanisms.

The core attention computation involves three key matrices: a query matrix Q of size Nq×d, and key and value matrices K, V each of size Nk×d. These matrices undergo three primary operations to produce the output: (1) computing attention scores through a matrix multiplication of Q and K transpose, (2) applying a softmax normalization to the scores, and (3) computing the final output through matrix multiplication with V. This process can be expressed mathematically as shown below in Equation 1:

$$S = Q K T , P = softmax ( S / √ d ) , O = P V$$

where:
Q is the query matrix ∈ RNq×d
K is the key matrix ∈ RNk×d
V is the value matrix ∈ RNk×d
S is the attention score matrix ∈ RNq×Nk.
P is the softmax matrix ∈ RNq×Nk
O is the output matrix ∈ RNq×d
d is the head dimension

Table I, immediately below, summarizes the three operations involved in self-attention along with their corresponding dimensions involved in both decode and prefill-phase:

TABLE I
OPERATIONS IN SELF-ATTENTION. MATRIX
MULTIPLICATIONS ARE DESCRIBED IN
THE M × N × K FORMAT.

Operation Dimension

| Operation | Type | Prefill | Decode |
|---|---|---|---|
| query × key | MatMul | L × d × L | 1 × d × L |
| softmax | EleWise | L × L | 1 × L |
| attn_score × value | MatMul | L × L × d | 1 × L × d |

Conventional implementations face significant performance challenges due to their computational approach. The standard method requires computing and storing large intermediate matrices-specifically the attention score matrix S and softmax matrix P, both of size Nq×Nk—in global memory. This approach necessitates examining all tokens in a row to compute softmax normalization factors, resulting in high memory bandwidth requirements and large storage footprints that scale quadratically with sequence length. The computational complexity is O(NqNkd), dominated by the two matrix multiplications, while the memory requirements are O(NqNk). These characteristics make the standard attention implementation particularly inefficient for modern language models that process long sequences, especially during the decode phase where growing context lengths create increasing computational and memory pressure.

### FlashAttention-2

To mitigate the memory footprint and access overhead associated with storing the S and P matrices, FlashAttention introduced an adroit way of fusing all three operations: query×key MatMul, softmax, and attn_score×value MatMul into a single kernel, requiring no intermediate global memory reads and writes. To this end, it employs two strategies: tiling and recomputation. A representation of the FlashAttention-2 Algorithm is presented immediately below:
FlashAttention-2, Algorithm
1: Require: Load matrices Q∈RNq×d and K, V∈RNk×d into GMEM.
2: Require: Initialize Matrix O to (0) Nq×d∈RNq×d in GMEM.
3: Set block sizes Tm and Tn.
4: Partition Q, O as Qi, Oi∈RTm×d where i∈(1, Cm).
5: Partition K, V as Kj, Vj∈RTn×d where j∈(1, Cn).
6: for i=1 to Cm do
7: Load Qi from GMEM to SMEM.
8: Initialize mi to (−∞) Tm×1 and li to (0) Tm×1 ∈RTm×1 in SMEM.
9: for j=1 to Cn do
10: Load Kj, Vj from GMEM to SMEM.
11: Compute on-chip:
12: Si=QiKjT where Si∈RTm×Tn
13: minew=max(mi, rowmax(Si))
14: Pi=exp(Si−minew) where Pi∈RTm×Tn
15: linew=emi−minewli+rowsum(Pi)
16: Oinew=PiVj+diag(emi−minew)Oi
17: li=linew, mi=minew, Oi=Oinew
18: end for
19: Compute Oi=diag(li)−1Oi and write to GMEM.
20: Compute logexpsum Li=mi+log (li) and write to GMEM.
21: end for

By utilizing the online softmax algorithm, FlashAttention requires only a single pass over an entire row of tokens to compute their softmax, avoiding the need for a priori knowledge in standard attention computation.

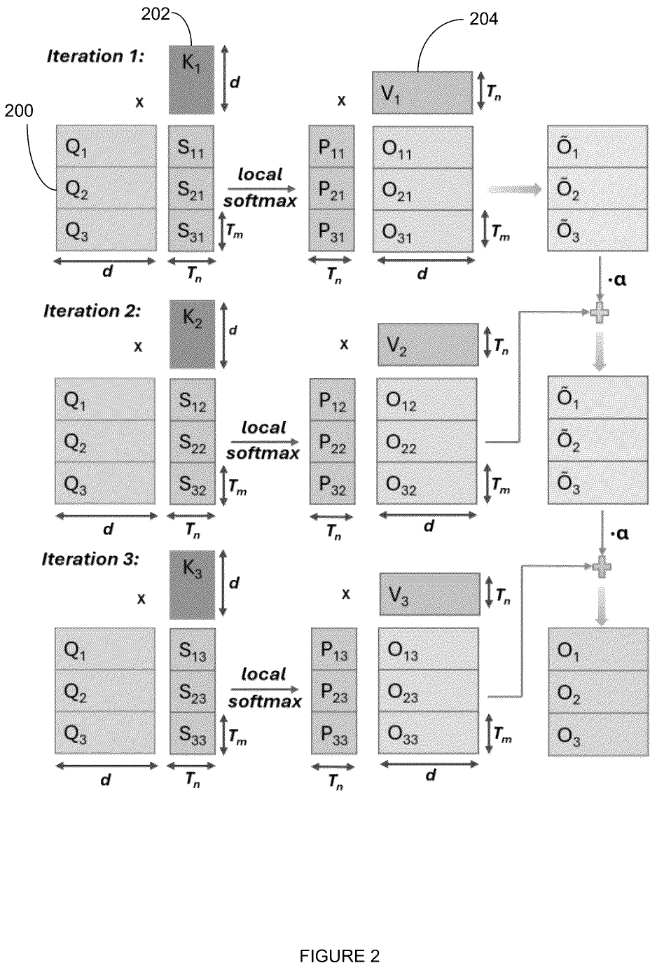

This enables a tiling strategy that partitions input matrices into smaller chunks that can be more efficiently loaded into shared memory. As shown in FIG. 2 for “Iteration 1”, the input matrices Q 200, K 202, and V 204 are partitioned into blocks, with each block having dimensions Tm×d for Q and Tn×d for K and V matrices.

The three core operations from the attention equation are fused together and computed locally for each chunk. As illustrated in FIG. 2, in each iteration (Iteration 1, Iteration 2, and Iteration 3), the algorithm performs matrix multiplication between Q and K blocks to generate attention score matrices (S11-S33), applies local softmax operations to generate probability matrices (P11-P33), and computes partial output matrices (O11-O33). To ensure accurate attention output, each partial output block is appropriately scaled using normalization parameter a during processing, before proceeding to compute the next chunk for a given output tile. This fused on-chip computation eliminates the need to store intermediate attention matrices in global memory.

FlashAttention-2 enhances parallelization by operating over batches, heads, and independent query blocks, achieving a 2× speedup compared to standrd FlashAttention. The algorithm implements two key memory optimizations: storing a logarithmic exponential sum instead of storing both local maximum and exponential sum matrices, and delaying the scaling of output blocks until the end to reduce computationally expensive non-matrix multiplication operations.

These optimizations and work partitioning strategies result in FlashAttention-2 requiring only O(Nq) additional global memory space for storing the logexpsum, which significantly improves upon the O(Nq×Nk) memory footprint of traditional attention approaches. The enhanced partitioning enables FlashAttention-2 to achieve 50-70% of peak theoretical floating point operations per second.

However, while FlashAttention-2's optimizations are effective for prefill-phase computations, the approach exhibits increased latency during the decode phase operations. This limitation arises because FlashAttention-2's partitioning strategy is not optimized for the unique computational characteristics of the decode phase, where query length is typically a single token but context length can be very long.

### Challenges in Decode Phase

As such, before detailing the methodology for LeanAttention, it is important to address some of the challenges encountered in the decode phase of LLM inference, as well as the limitations of FlashAttention-2 optimizations in the decode phase.

### Time Spent in Decode

Generative LLM inference comprises two distinct computational phases: the prefill phase and the decode phase. In the prefill phase, all tokens in the input prompt undergo parallel forward passes through the model to generate the first output token. During this phase, the query length (Nq) equals the context length (Nk), resulting in an N×N attention matrix. This computationally intensive phase demands high floating point operations per second.

Following the prefill phase, the decode phase begins generating subsequent output tokens through an auto-regressive process, where each new token is produced based on the forward pass of the preceding token and the cached context (KV cache) from previous tokens in the sequence. During each iteration of the decode phase, the query length is a single token (Nq=1), while the context length (Nk) can extend to thousands of tokens depending on the auto-regressive step and input prompt length. This characteristic makes parallelization along the context length dimension crucial for optimizing decode phase processing time.

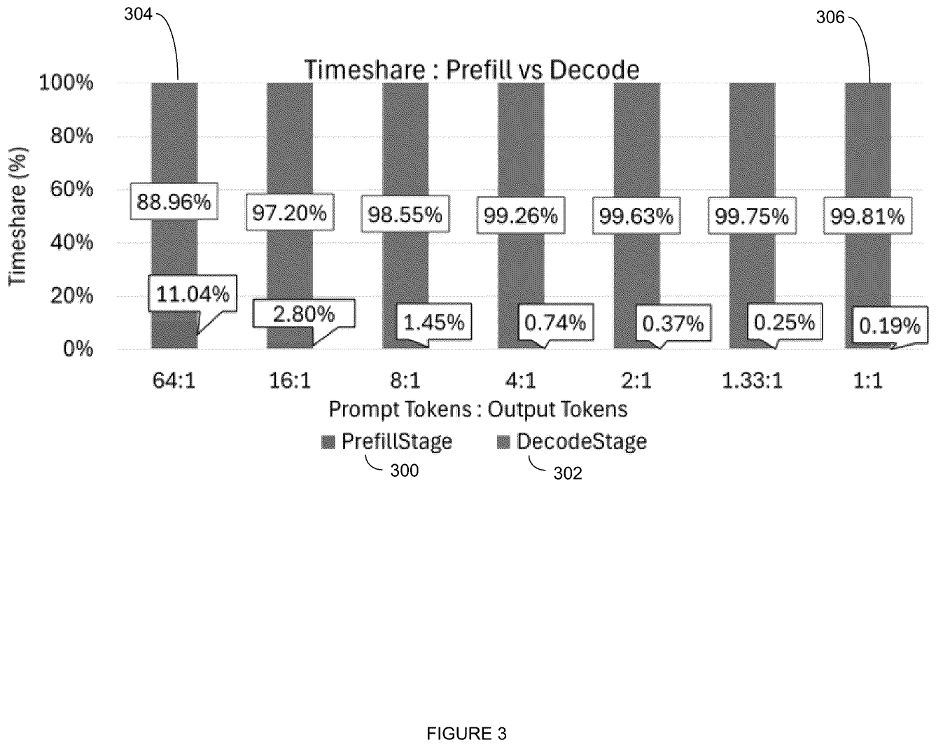

As illustrated in FIG. 3, the proportion of processing time spent in the decode phase 302 increases significantly relative to the prefill phase 300 as more output tokens are generated. The timeshare graph shows that even with a prompt-to-output token ratio of 64:1 304, the decode phase consumes 88.96% of the total processing time. This proportion grows even larger for longer output sequences, approaching nearly 100% timeshare when the ratio approaches 1:1 306. These measurements demonstrate the critical importance of optimizing decode phase performance, particularly for generating longer output sequences.

### Limitations of FlashAttention-2 for Decode

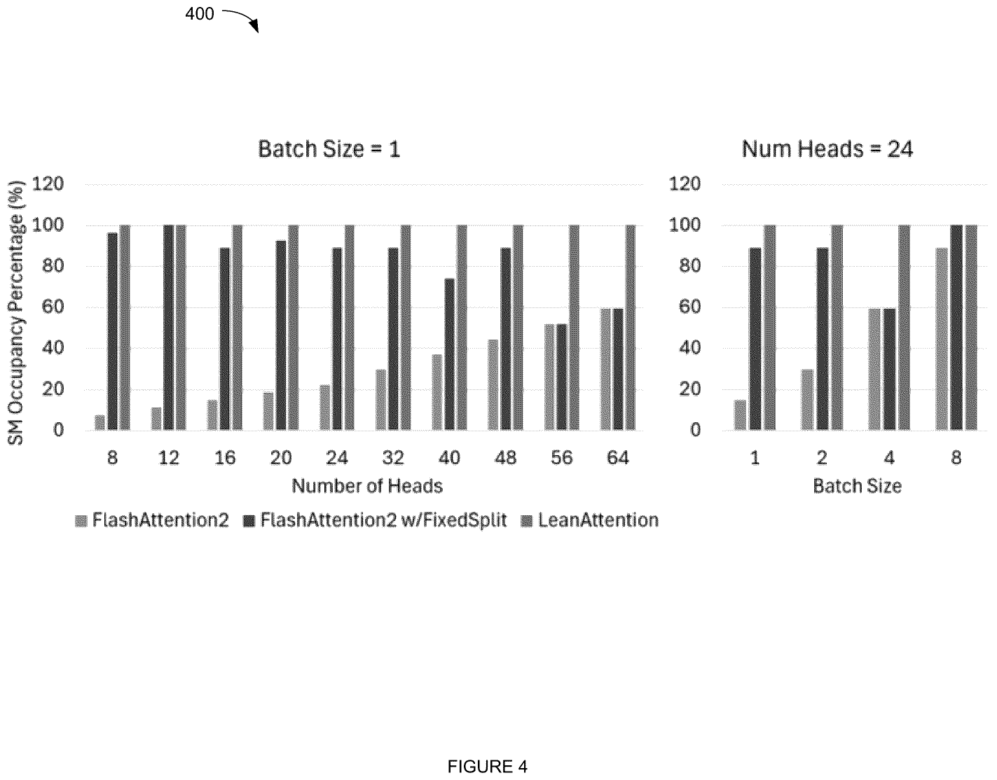

In both prompt and decode phases, FlashAttention-2 computes sequentially along the context length dimension, following dependencies introduced by the softmax operation. As shown in FIG. 4, while FlashAttention-2 attempts to parallelize over query lengths to increase streaming multiprocessor (SM) occupancy, this parallelization has limited benefit during the decode phase where query length equals one token. The occupancy graph 400 demonstrates that standard FlashAttention-2 achieves only minimal SM utilization, particularly with smaller numbers of attention heads. This low utilization stems from FlashAttention-2's sequential processing of key/value tiles, where the number of concurrent cooperative thread arrays (CTAs) is constrained by the query sequence length.

For a single batch instance with query length Nq=1, even models with 128 attention heads struggle to efficiently utilize modern hardware architectures during the decode phase. The batch size comparison illustrates that a model with 24 attention heads operating on an 8-GPU A100 system with 864 compute cores shows severely limited parallelization opportunities, restricted only to batch size and number of heads.

While processor occupancy could theoretically be improved by increasing batch sizes or attention heads, practical limitations make this approach infeasible. Larger batch sizes in the decode phase would require independently caching key-value context for each batch instance, quickly exceeding available memory capacity. Additionally, scheduling overheads and challenges with batching low-latency queries create further complications for inference optimization.

The large context lengths typical in decode phase operations would benefit from efficient workload partitioning across different SMs, rather than relying solely on increased batch sizes. This limitation motivates the development of more sophisticated attention decomposition techniques that can effectively distribute computational work across available cores while maintaining memory efficiency.

FlashAttention-2 with Fixed-Split Partitioning

FlashAttention-2 with fixed-split partitioning (FlashDecoding) attempts to address these limitations by enabling parallelization along the context length dimension. This approach optimizes concurrent computation through matrix multiplication decomposition, launching multiple CTAs to compute partial products in parallel. The technique leverages the associative property of addition to combine these partial results through a reduction operation.

However, as demonstrated by the SM occupancy measurements in FIG. 4, fixed-split partitioning faces significant limitations. The approach requires an additional reduction kernel, introducing overhead costs that scale with problem size. The fixed decomposition pattern results in quantization inefficiencies, shown by variable occupancy levels 412 across different problem configurations. While achieving higher utilization than standard FlashAttention-2, the actual GPU resource usage varies significantly based on parameters like number of heads, batch size, and context length.

In contrast, LeanAttention's stream-K-style decomposition ensures optimal workload distribution, as evidenced by the consistent 100% GPU occupancy shown across all configurations in FIG. 4. This approach maintains high hardware utilization regardless of problem size or architecture specifications.

Multi-GPU Execution with Tensor Parallelism

These limitations highlight the need for a generalized attention mechanism optimized for both prefill and decode phases while aligning with modern hardware architectures. LeanAttention addresses these challenges through single-kernel execution, optimal quantization efficiency, and tensor parallelism support for multi-GPU scalability.

### LeanAttention

LeanAttention, consistent with some embodiments, is an optimized scalable execution mechanism for computing the self-attention. It provides extensive parallelism across all modes of the attention tensor, with well-balanced computation workload to each CTA ensuring close to 100% SM occupancy delivering a runtime speedup in attention execution as a result.

Consistent with some embodiments, LeanAttention achieves this by leveraging two key ideas. First, we identify that the associative property of softmax re-scale operation enables the softmax operation to be treated as a reduction operation along the context-length dimension of the attention operation. Second, the reductive property is leveraged to split the attention computation into optimal and lean blocks of work, termed as LeanTile, which can be mapped on the hardware resources in a flexible style akin to ‘stream-k’ decomposition of matrix multiplications.

Below, identification of softmax re-scaling as a reduction operation is outlined, followed by a conceptualization of a LeanTile as a unit granularity in a CTA block and the stream-K style mapping within these CTAs, followed by an explanation of the overall execution flow of LeanAttention.

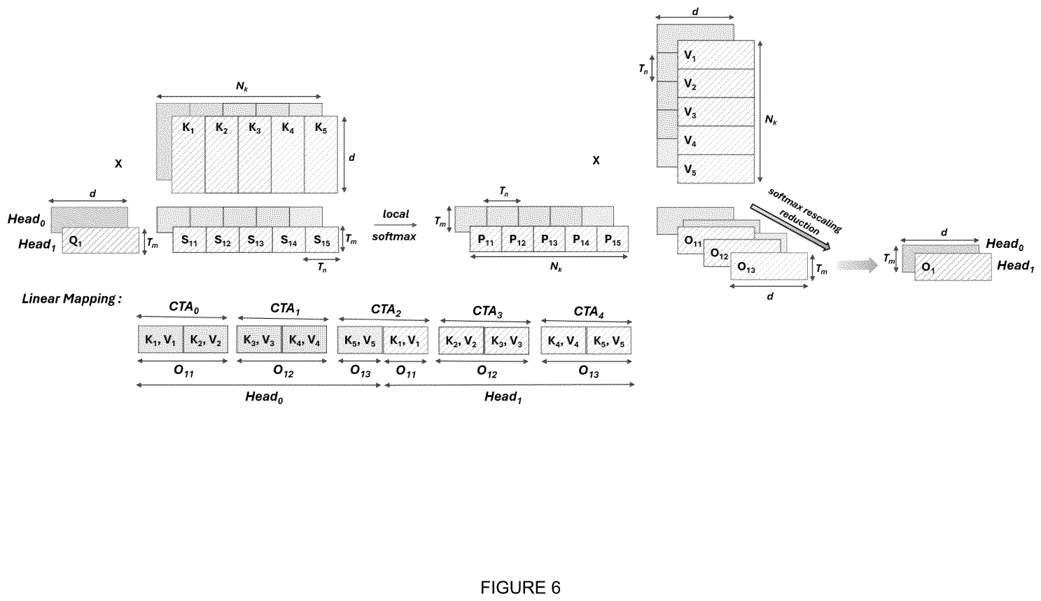

FIG. 6 illustrates the execution flow of LeanAttention through several key components and operations.

### Softmax Re-scaling as Reduction

A key part of the attention mechanism is the softmax operation which couples entire rows or blocks of rows. Online softmax can split the attention computation in blocks, and rescale the output of each block incrementally to finally get the result. FlashAttention-2 leveraged this technique to compute attention by adopting this online-softmax technique on top of tiling for performing the matrix multiplication; however, this is done in an incremental way to compute the exact attention. Consistent with embodiments, this concept is extended to completely split the computation into distinct blocks and then re-scaling the outputs separately.

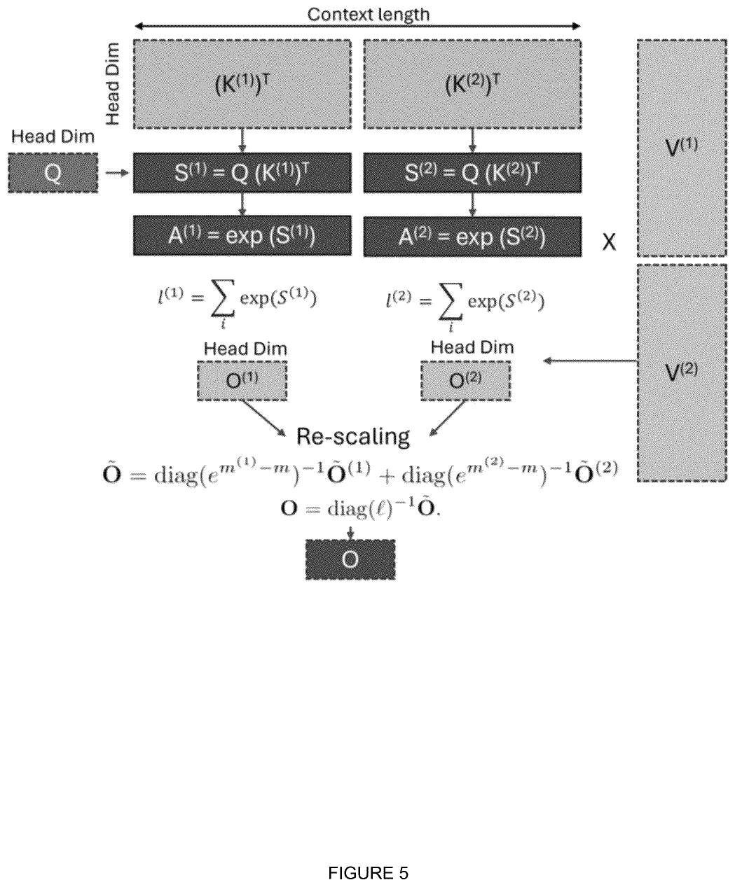

The improvement is described using a similar example as FlashAttention-2, comprising of two blocks, without the loss of any generality. Consider just one row block of the attention matrix S, of the form S(1) S(2) for some matrices S(1), S(2)∈RBr×Bc, where Br and Bc are the row and column block sizes. This was computed from Q×(K(1)) T and Q×(K(2)) T as shown in FIG. 5. Note that the context length of K(1) and K(2) are not necessarily equal. To compute softmax of this row block and multiply with the value, of the form V(1) V(2) for some matrices V(1), V(2)∈RBc×d, FlashAttention-2 would compute it as:

$$S ( 1 ) = Q ( K ( 1 ) ) T$$

$$m ( 1 ) = rowmax ( S ( 1 ) ) ∈ R B r$$

$$ℓ ( 1 ) = rowsum ( eS ( 1 ) - m ( 1 ) ) ∈ RBr$$

$${O}^{∼} ( 1 ) = e S ( 1 ) - m ( 1 ) V ( 1 ) ∈ R B r \times d$$

$$S ( 1 ) = Q ( K ( 1 ) ) T$$

$$m ( 2 ) = max ( m ( 1 ) , row max ( S ( 2 ) ) ) = m$$

$$ℓ ( 2 ) = e m ( 1 ) - m ( 2 ) ℓ ( 1 ) + rowsum ( eS ( 2 ) - m ( 2 ) )$$

$$ℓ ( 2 ) = rowsum ( eS ( 1 ) - m ) + rowsum ( eS ( 2 ) - m ) = ℓ$$

$${P}^{∼} ( 2 ) = diag ( ℓ ( 2 ) ) - 1 e S ( 2 ) - m ( 2 )$$

$${O}^{∼} ( 2 ) = diag ( em ( 1 ) - m ( 2 ) ) - 1 {O}^{∼} ( 1 ) + e S ( 2 ) - m ( 2 ) V ( 2 )$$

$${O}^{∼} ( 2 ) = e s ( 1 ) - m V ( 1 ) + e s ( 2 ) - m V ( 2 )$$

$$O ( 2 ) = d i ag ( ℓ ( 2 ) ) - 1 {O}^{∼} ( 2 ) = O$$

However, this can be further split into an individual ‘local’ calculation of softmax and then re-scaling at the end. The online-softmax trick thus splits into two parts. The first part involves calculation of an ‘un-scaled’ version of O(i) along with statistics [symbol] (i):

$$S ( 1 , 2 ) = Q ( K ( 1 , 2 ) ) T$$

$$m ( 1 , 2 ) = row max ( S ( 1 , 2 ) ) ∈ RBr$$

$$ℓ ( 1 , 2 ) = rowsum ( eS ( 1 , 2 ) - m ( 1 , 2 ) ) ∈ RBr$$

$${O}^{∼} ( 1 , 2 ) = e S ( 1 , 2 ) - m ( 1 , 2 ) V ( 1 , 2 ) ∈ R B r \times d$$

The second part involves re-scaling the ‘un-scaled’ outputs O″ (i) using the statistics [symbol] (i). Thus, for the case of 2 blocks, the reduction part becomes:

$$m = max ( m ( 1 ) , m ( 2 ) )$$

$$ℓ = em ( 1 ) - m ℓ ( 1 ) + e m ( 2 ) - m ℓ ( 2 )$$

$${O}^{∼} = diag ( em ( 1 ) - m ) - 1 {O}^{∼} ( 1 ) + diag ( em ( 2 ) - m ) - 1 {O}^{∼} ( 2 )$$

$$O = diag ( ℓ ) - 1 {O}^{∼}$$

The second-part of this computation (re-scaling) enables the ‘partial’ outputs to be individually calculated and then ‘reduced’ to obtain the final exact attention. The associative property in LeanAttention is leveraged to split the calculation of these partial output tiles into blocks and then reduce them later. Unlike fixed-split decomposition, this associative property allows for breaking them into blocks of any size and re-scaling them later to compute the exact attention. The overall flow is presented as an algorithm, immediately below, which is then further described and explained below.
Lean Attention, Algorithm-Basic Algorithm
1: Require: Load matrices Q∈RNq×d and K, V∈RNk×d into GMEM.
2: Require: Initialize Matrix O to (0) Nq×d∈RNq×d in GMEM.
3: Set block sizes Tm and Tn.
4: Partition Q, O as Qi, Oi∈RTm×d where i∈(1, Cm).
5: Partition K, V as Kj, Vj∈RTn×d where j € (1, Cn).
6: for i=1 to Cm do
7: for j=1 to Cn do
8: Load Qi, Kj, Vj from GMEM to SMEM of an SM.
9: Initialize Oij to (0) Tm×d∈RTm×d in SMEM.
10: Initialize mij to (−∞) Tm×1 and lij to (0) Tm×1 ∈RTm×1 in SMEM.
11: Compute on-chip:
12: Sij=QiKjT where Sij∈RTm×Tn
13: mij=rowmax(Sij) where mij∈RTm×1
14: Pij=exp(Sij−mij) where Pij∈RTm×Tn
15: Oij=PijVj where Oij∈RTm×d
16: lij=rowsum(Pij) where lij∈RTm×1
17: end for
18: end for
19: for i=1 to Cm do
20: for j=1 to Cn−1 do
21: minew=max(mi, mij)
22: linew=emi−minewli+emij−minewlij
23: Oinew=emi−minewOi+emij−minewOij
24: Update mi=minew, li=linew
25: end for
26: Compute Oi=diag(li)−1Oi and write to GMEM.
27: Compute logexpsum Li=mi+log (li) and write to GMEM.
28: end for

Similar to FlashAttention-2, the attention score matrix is first partitioned into tiles of dimensions Tm×Tn. This corresponds to the nested for loops in Line 6 and 7 of the above LeanAttention Algorithm. The query activation matrix and the attention output matrix is partitioned into Cm tiles of sizes Tm×d each and the key and value activation matrices are partitioned into Cn tiles of sizes Tn×d, making the attention matrix S a grid of CmCn tiles, as seen in Line 4 and 5 (see also FIG. 6). The query×key MatMul is calculated, followed by softmax to give the attention score matrix, and then the attn score×value MatMul is calculated to give the partial attention output matrix. Finally, the softmax re-scaling out of the inner loop of FlashAttention-2 is extracted and treated as a reduction operation to accumulate the partial output tiles.

### LeanTile

To efficiently distribute the work of computing the partial output tensors, a block is defined as a LeanTile. A single lean tile iteration computes ‘local attention’ across a subset of tokens along the Nk dimension. Thus, a LeanTile takes in a query, key, and value tensors and computes the local attention to generate the un-scaled attention outputs.

The LeanTile ( ) Algorithm, depicted below, illustrates a subroutine for computing the partial attention outputs for that tile. This LeanTile ( ) subroutine is called when computing each partial output tile in a CTA launched in Lean Attention as will be discussed below.
LeanTile ( ) subroutine Algorithm, for a sequence of lean tile iterations
1: function LeanTile (tile_idx, iter_begin, iter_end)
2: shared Oacc[Tm,d]
3: shared Qf[Tm,d]
4: shared Kf[Tn,d]
5: shared Vf[Tn,d]
6: shared m[Tm, 1]
7: shared l[Tm, 1]
8: Initialize Oacc to (0) Tm×d∈RTm×d in SMEM.
9: Initialize m to (−∞) Tm×1 and 1 to (0) Tm×1∈RTm×1 in SMEM.
10: mm=Tm×(tile_idx/1)
11: nn=d×(tile_idx % 1)
12: Perform lean tile iterations for this output tile.
13: for iter=iter_begin to iter_end do
14: kk=iter×Tn
15: load fragments from GMEM to SMEM
16: Qf=LoadFragment(Q,mm,nn)
17: Kf=LoadFragment(K,nn,kk)
18: Vf=LoadFragment(V,nn,kk)
19: Compute on chip:
20: Sf=QfKf where Sf∈RTm×Tn
21: mnew=max(m,rowmax(Sf))
22: Pf=exp(Sf−mnew) where Pf∈RTm×Tn
23: lnew=em−mnewl+rowsum (Pf)
24: Oacc=PfVf+diag(em−mnew) Oacc
25:1=lnew, m=mnew
26: end for
27: return Oacc, 1, m
28: end function

To efficiently split attention into smaller tiles, it is necessary to identify the smallest tile size capable of achieving highest compute efficiency. After extensively sweeping through various sizes for a LeanTile, we found that a tile size granularity of 256 and 128 tokens along the Nk dimension to be the most optimal for a head size of 64 and 128 respectively for FP16→32 problems while experimenting on an A100 GPU. This optimal size can similarly be identified for other head dimensions and hardware architectures.

### Decomposition and Mapping of Lean Tiles

Finally, consistent with some embodiments, LeanAttention uses a stream-K style decomposition and mapping of these LeanTiles to deliver efficient execution of attention. Stream-K is a parallel decomposition technique for dense matrix-matrix multiplication on GPUs. Stream-k partitioning addresses the inefficiencies in fixed-split by dividing the total workload (MAC operations) equally to all the CTAs using a pre-determined optimal tile size for dense matrix-matrix multiplications. It does this by rolling out the inner mode iterations of all output tiles and appending them along the inner mode to form a linear mapping. With the given grid size, it divides this total work into buckets demarcated appropriately such that each CTA has equal amount of iterations to perform. This grid size is determined by heuristics that sweep through all possible grid sizes and find the most optimal one which enables extensive parallelism and optimal wave quantization that compensate well for any overhead that comes from reduction of the partial outputs.

LeanAttention extends Stream-K style of linear mapping of iterations, LeanAttention rolls out LeanTile iterations in a similar fashion, assigning equal number of Nk token iterations to each lean attention CTA as shown in FIG. 6. Each CTAs range of Nk iterations is mapped contiguously into the batch size→heads→context length linearization, crossing the head and query boundary as it may. Should a given CTA's starting and/or ending iterations not coincide with the head boundary, it must consolidate its partial outputs with those of the other CTA(s) also covering that tile. In our implementation of LeanAttention, each output attention tensor is computed by the CTA that performed the tile's Nk=0 token (called as a host block). Before it can do so, however, it must accumulate the un-scaled output tensors from other CTAs in temporary global storage, as shown in FIG. 1. The negligible synchronization overhead of original stream-K implementation also extends to LeanAttention, thus leading to near 100% occupancy of SMs (not tensor core utilization) during the execution of a single CTA. Note that the temporary global storage overhead is minimal in the case of decode-phase where the output tensors are of dimensions 1×head dim, where head dim is typically in the range of 64 to 256.

Further, since we distribute the overall attention problem into optimal LeanTiles, we achieve a near 100% quantization efficiency irrespective of problem size (context length). This cohesive implementation of parallel computation and reduction happens in a single kernel launch in LeanAttention, avoiding the reduction kernel launch overheads that FlashAttention-2 with fixed-split suffers from. A difference in Stream-K decomposition in Lean Attention is in the reduction or ‘fix-up’ phase. While Stream-K for MatMuls has addition as its reductive operation, Lean Attention has softmax rescaling and accumulation as its reductive operation.

Naturally, some CTA's will be computing LeanTile iterations of more than one output tile. In such cases, stream-K's equalized partitioning makes lean attention more adept for problem sizes which would not occupy the hardware well if executed using its counterparts, FlashAttention-2 and FlashAttention-2 with fixed-split. To enable such a smooth transition between tiles, the input tensor view is also different in LeanAttention compared to FlashAttention-2. This requires a constant stride moving between different heads as we transition from a LeanTile of a head to another requiring query, key, and value tensors be of the shape (batch size, heads, query/ctx length, head dim) compared to FlashAttention-2's requirement of (batch size, query/ctx length, heads, head dim).

With this design of execution, LeanAttention behaves as a versatile attention partitioning mechanism that generalizes to FlashAttention-2 in the case where the number of output tiles is equal to grid size, and generalizes to FlashAttention-2 with Fixed-split when grid size is an even multiple of number of output tiles. Finally, for all other cases (most common) LeanAttention efficiently distributes the work across the compute resources available in the system. Thus, LeanAttention will either always perform better or the same as FlashAttention-2 with or without Fixed-split.

### Execution Flow

The following illustrates an algorithm for the execution flow:
Algorithm: LeanAttention-StreamK Style Execution
1: shared O[Tm,d]
2: shared m[Tm, 1]
3: shared l[Tm, 1]
4: Number of output tiles: Cm=[Nq/Tm]
5: Number of iterations per output tile: Cn=[Nk/Tn]
6: Total iterations: I=CmCn
7: Iterations per CTA: IG=I/G
8: fork CTAg in G do
9: cta_start=g*IG and cta_end=cta_start+IG
10: for iter=cta_start to cta_end do
11: Current tile index: tile_idx=iter/Cn
12: tile_iter=tile_idx*Cn
13: tile_iter_end=tile_iter+Cn
14: local_iter=iter-tile_iter
15: local_iter_end=min (tile_iter_end, cta_end)−tile_iter
16: O, m, 1=LeanTile (tile_idx, local_iter, local_iter_end)
17: host_block if: iter==tile_iter
18: finishing_block if: cta_end>=tile_iter_end
19: if! (host_block) then
20: StorePartials (Op[g], O)
21: StorePartials(mp[g], m)
22: StorePartials(lp[g], l)
23: Signal (flags[g])
24: else
25: if! (finishing_block) then
26: last_cta=tile_iter_end/Cn
27: for cta=(g+1) to last_cta do
28: Wait (flags [cta])
29: mcta=LoadPartials(mp [cta])
30: 1cta=LoadPartials(lp [cta])
31: Octa=LoadPartials (Op [cta])
32: mnew=max(mcta, m)
33: lnew=emcta−mnewlcta+em−mnewl
34: Onew=emcta−mnewOcta+em−mnewO
35: Update m=mnew, 1=lnew
36: end for
37: end if
38: Write O=diag(1)-1*O to GMEM
39: Write L=m+log (1) to GMEM
40: end if
41: iter=tile_iter_end
42: end for
43: join

The above algorithm specifically depicts a StreamK style execution of Lean Attention. For a fixed grid size G, CTA's are launched and given equal amount of lean tiles to work with. Each CTA block computes LeanTile ( ) iterations for every distinct output tile that comes under its boundaries.

The unique reduction phase of LeanAttention characterized by its softmax rescaling and output tile accumulation is performed by the host CTA block. A host CTA is the CTA responsible for computing the first ever LeanTile for a given output tile, and it behaves as the consumer tile during parallel reduction of partial tiles. Similarly, a finishing CTA block is the block which computes the last ever LeanTile for a given output tile.

All non-host blocks will share their partials through global memory and signal their arrival. On the other hand, a host block which is a non-finishing block needs to wait for other contributing peer CTA blocks to signal their completion and then proceed to carry out the reduction.

A host block that is also a finishing block completes all the LeanTile iterations for its output tile in a single CTA and so can directly store its results from LeanTile ( ) in global memory without any reduction.

### Example Embodiments

In one example embodiment, a method is provided for increasing computational efficiency of attention operations in transformer-based language models.

The method begins by receiving an input sequence of tokens, where each token represents a discrete unit of input data for processing by the transformer model. From these tokens, vector representations are generated with a predetermined embedding size. The vector representations are then used to generate query, key, and value matrices as input data for the attention operation.

The attention operation is unequally partitioned into multiple computational units based on several key factors: the total number of tokens in the sequence, the number of attention heads in the model, the embedding size of the vector representations, and the number of available multiprocessors in the hardware. Each computational unit has a variable size and represents a subset of tokens along the context length dimension. This unequal partitioning enables optimal workload distribution across the hardware resources.

The computational units are distributed across the GPU's streaming multiprocessors using a stream-K style decomposition approach. This involves rolling out iterations of the computational units to form a linear mapping and dividing the total workload into buckets such that each cooperative thread array receives an equal number of iterations to perform. The distribution allows for crossing attention head and query boundaries to maximize hardware utilization.

The attention operation executes in parallel across the computational units, with each unit computing a partial attention output. This parallel execution includes computing local attention score matrices, performing local softmax operations, and storing critical statistics like local maximums and exponential sums. These partial outputs are then combined through a reduction operation that includes softmax re-scaling and accumulation, performed in a single fused kernel without requiring additional reduction kernels.

For the decode phase specifically, the method processes single tokens as input, representing discrete units for each step. The system retrieves cached key-value tensors from previous tokens and generates input data for subsequent attention operations. The same unequal partitioning and parallel execution approach is applied, but with the computational units distributed based on the cached key-value tensor length rather than the full sequence length.

The method achieves significant performance improvements through several key innovations: treating softmax re-scaling as an associative reduction operation, implementing optimal LeanTile sizes for different head dimensions, and ensuring near 100% GPU occupancy through flexible workload distribution. This approach enables efficient processing of both short and long context lengths while maintaining computational accuracy and hardware efficiency.

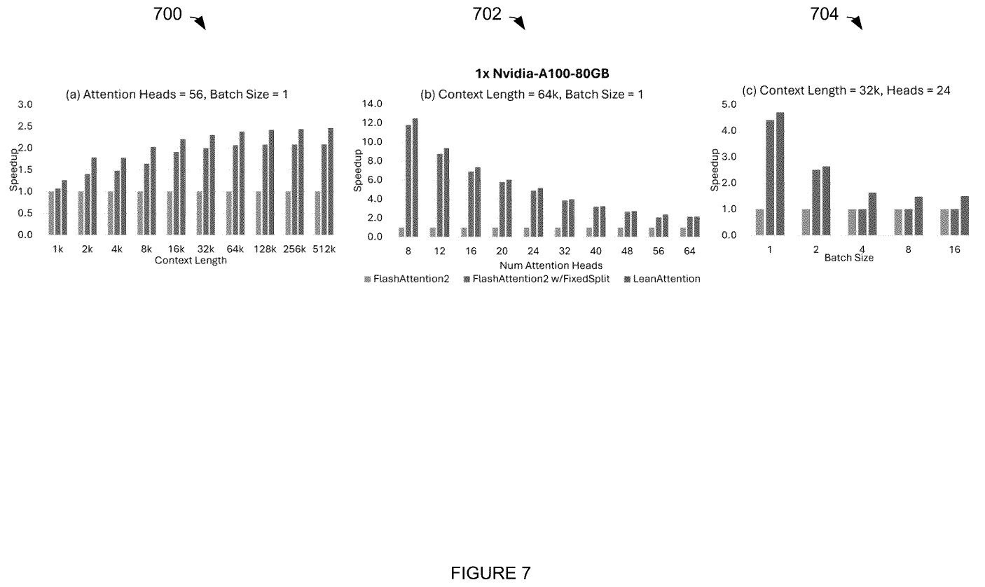

FIG. 7 illustrates performance comparisons between LeanAttention and prior approaches across different operational scenarios on a single Nvidia A100-80 GB GPU. The figure includes three key graphs.

Graph 700 shows speedup measurements with 56 attention heads and batch size of 1 across varying context lengths from 1k to 512k tokens. LeanAttention demonstrates consistently superior performance, achieving up to 2.46× speedup compared to FlashAttention-2 at longer context lengths.

Graph 702 depicts performance with context length of 64k and batch size of 1, varying the number of attention heads from 8 to 64. LeanAttention delivers significant speedup, reaching 12.5× improvement with smaller numbers of heads, while maintaining 2.15× speedup even with 64 heads.

Graph 704 illustrates speedup measurements with context length of 32k and 24 attention heads across different batch sizes. LeanAttention achieves 4.71× speedup over FlashAttention-2 for single-batch operations and maintains 1.5× improvement even at higher batch sizes.

This demonstrates LeanAttention's ability to efficiently utilize hardware resources across varying workload configurations. The comprehensive benchmarking results shown in FIG. 7 demonstrate LeanAttention's consistent performance advantages over prior approaches, particularly in scenarios involving longer context lengths and smaller batch sizes.

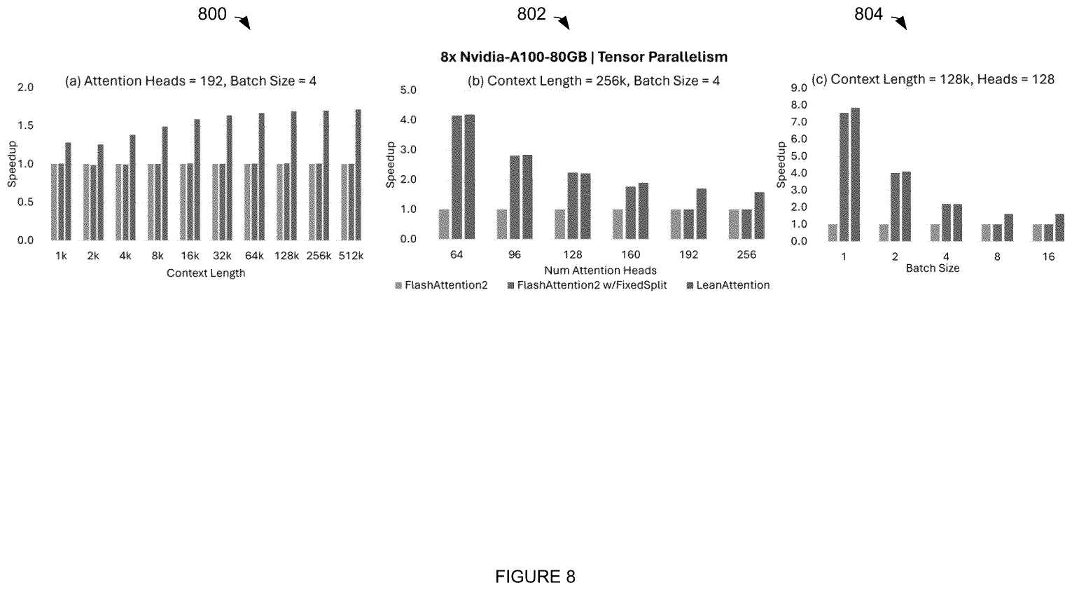

FIG. 8 illustrates performance comparisons between LeanAttention and prior approaches in a multi-GPU environment using tensor parallelism across 8 Nvidia A100-80 GB GPUs. The figure includes three key graphs.

Graph 800 demonstrates speedup measurements with 192 attention heads and batch size of 4 across varying context lengths from 1k to 512k tokens. LeanAttention shows consistently superior performance, achieving up to 1.7× speedup compared to both FlashAttention-2 and FlashAttention-2 with fixed-split at longer context lengths.

Graph 802 shows performance with context length of 256k and batch size of 4, varying the number of attention heads from 64 to 256. LeanAttention delivers significant speedup, reaching 4.18× improvement with smaller numbers of heads (64), while maintaining performance advantages even as the number of heads increases.

Graph 804 depicts speedup measurements with context length of 128k and 128 attention heads across different batch sizes. LeanAttention achieves 7.8× speedup over FlashAttention-2 variants for single-batch operations and maintains performance advantages even at higher batch sizes.

This demonstrates LeanAttention's ability to efficiently utilize distributed hardware resources across varying workload configurations, particularly in scenarios where batching opportunities are limited. The benchmarking results shown in FIG. 8 highlight LeanAttention's consistent performance advantages in multi-GPU environments, especially for configurations involving longer context lengths and scenarios where batching may be constrained.

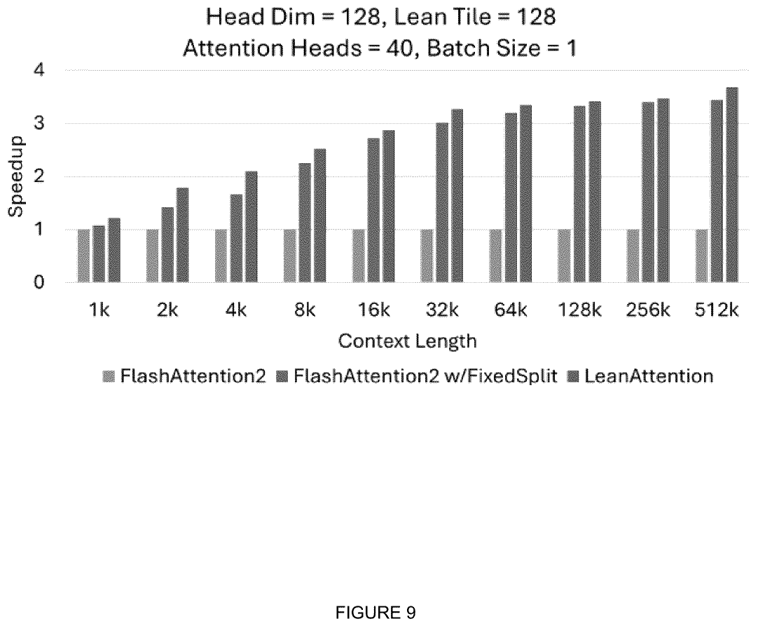

FIG. 9 illustrates performance comparisons between LeanAttention and prior approaches for transformer models utilizing larger head dimensions. The graph shows performance measurements with a head dimension of 128 and an optimized LeanTile size of 128 tokens across varying context lengths from 1k to 512k tokens. The configuration uses 40 attention heads and a batch size of 1 to demonstrate the efficiency gains in scenarios with limited batching opportunities.

The performance comparison is visualized through three distinct bars for each context length measurement point: FlashAttention-2 (shown in light gray), FlashAttention-2 with fixed-split (shown in medium gray), and LeanAttention (shown in dark gray). The results demonstrate LeanAttention's superior performance scaling, achieving up to 3.67× speedup compared to FlashAttention-2 at the maximum context length of 512k tokens. Even at smaller context lengths of Ik tokens, LeanAttention maintains a performance advantage with a 1.2× improvement over baseline implementations.

The graph demonstrates LeanAttention's consistent performance advantages across the entire range of context lengths, with the performance gap widening as context length increases. This illustrates LeanAttention's efficient scaling capabilities and particular effectiveness when processing larger head dimensions, which are becoming increasingly common in modern transformer architectures.

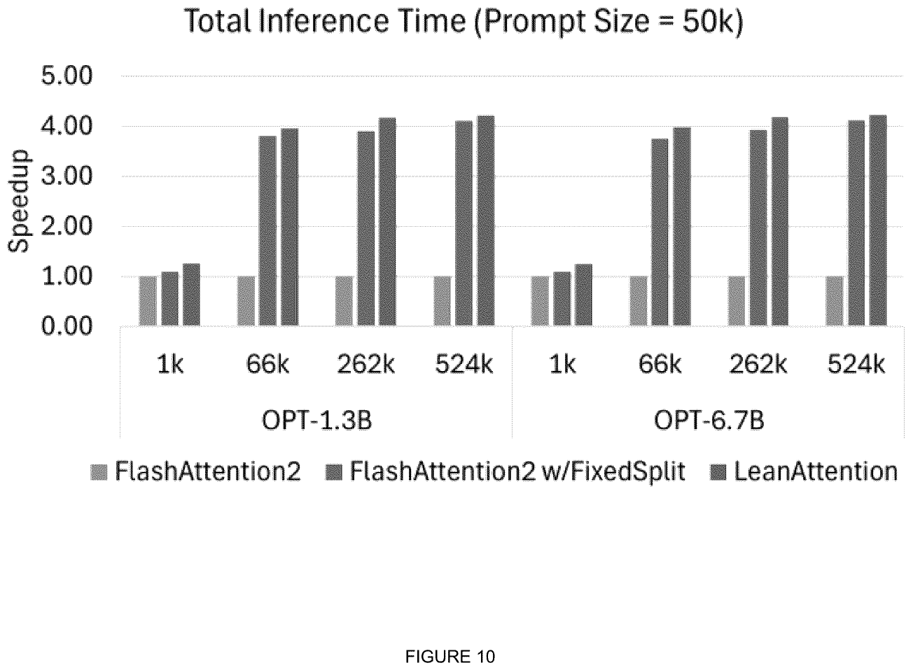

FIG. 10 illustrates end-to-end inference performance comparisons between LeanAttention and prior approaches across different model sizes and output sequence lengths. The figure shows performance measurements with a fixed prompt size of 50,000 tokens 1000 for two different model configurations: The left side shows results for OPT-1.3B 1002, a 1.3 billion parameter model, while the right side shows results for OPT-6.7B 1004, a 6.7 billion parameter model. For each model, measurements are taken at different output sequence lengths: 1k, 66k, 262k, and 524k tokens 1006.

The y-axis displays speedup ratios 1008 comparing three implementations: FlashAttention-2 1010 (light gray bars), FlashAttention-2 with fixed-split 1012 (medium gray bars), and LeanAttention 1014 (dark gray bars). LeanAttention demonstrates consistent performance advantages, delivering a 1.26× speedup for the first 1,000 output tokens and reaching up to 4.0× speedup as output length increases beyond 64,000 tokens.

The performance improvements are maintained across both model sizes, with LeanAttention showing an average 4.0× speedup compared to FlashAttention-2 and 1.06× speedup over FlashAttention-2 with fixed-split for longer output sequences. These results demonstrate LeanAttention's ability to efficiently handle inference workloads across different model scales and output lengths while maintaining consistent performance advantages over prior approaches.

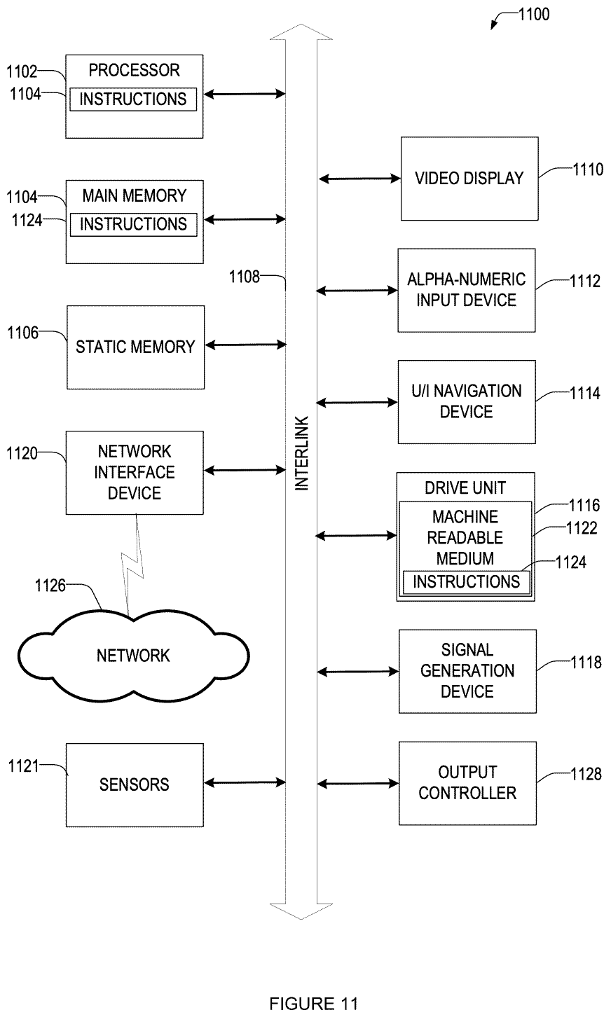

FIG. 11 illustrates a block diagram of an example machine 1100 upon which any one or more of the techniques (e.g., methodologies) discussed herein may be performed. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term ‘machine’ shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter ‘components’). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term ‘component’ is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 1100 may include one or more hardware processors, such as processor 1102. Processor 1102 may be a central processing unit (CPU), a graphics processing unit (GPU), a hardware processor core, or any combination thereof. Machine 1100 may include a main memory 1104 and a static memory 1106, some or all of which may communicate with each other via an interlink (e.g., bus) 1108. Examples of main memory 1104 may include Synchronous Dynamic Random-Access Memory (SDRAM), such as Double Data Rate memory, such as DDR4 or DDR5. Interlink 1108 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term ‘machine readable medium’ may include a single medium or multiple media (e.g., a centralized or distributed database, and/or associated caches and servers) configured to store the one or more instructions 1124.

The term ‘machine readable medium’ may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1124 may further be transmitted or received over a communications network 1126 using a transmission medium via the network interface device 1120. The Machine 1100 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. In some examples, the network interface device 1120 may wirelessly communicate using Multiple User MIMO techniques.

What is claimed is:

1. A method for increasing the computational efficiency of an attention operation computation in a transformer-based language model executed on a hardware processor having a plurality of multiprocessors, the method comprising:
receiving as input to the transformer-based language model a sequence of tokens, each token representing a discrete unit of input data for the transformer-based language model;
generating, from the sequence of tokens, vector representations of each token, wherein each vector representation has a predetermined embedding size;
generating, from the vector representations of each token, input data for the attention operation, the input data including query, key, and value matrices;
unequally partitioning the attention operation into a plurality of computational units for distributing to the plurality of multiprocessors of the hardware processor based on a total number of tokens in the sequence of tokens, a number of attention heads in the transformer-based language model, the predetermined embedding size of a vector representation of a token, and the number of multiprocessors of the GPU, wherein each computational unit has a variable size and represents a subset of tokens from the sequence of tokens along a context length dimension;
distributing the computational units across the multiprocessors of the GPU;
executing the attention operation for each computational unit in parallel, wherein each computational unit computes a partial attention output;
performing a reduction operation to combine the partial attention outputs from the computational units, wherein the reduction operation includes softmax re-scaling and accumulation;
generating a final attention output for the attention operation based on the combined partial attention outputs; and
generating by the transformer-based language model an output, responsive to the input to the transformer-based language model, by processing the final attention output through subsequent layers of the transformer-based language model.

2. The method of claim 1, wherein unequally partitioning the attention operation into a plurality of computational units comprises:
determining a total workload based on the total number of tokens in the sequence of tokens, the number of attention heads in the transformer-based language model, and the predetermined embedding size of a vector representation of a token;
dividing the total workload associated with all computational units by the number of multiprocessors of the GPU to determine an equal work allocation for each multiprocessor;
creating computational units of variable sizes, each representing a subset of embeddings of tokens from the sequence of tokens along a context length dimension; and
assigning the computational units to the multiprocessors such that the sum of workloads for computational units assigned to each multiprocessor equals the determined equal work allocation.

3. The method of claim 1, wherein distributing the computational units across the multiprocessors of the GPU comprises using a stream-K style decomposition.

4. The method of claim 3, wherein the stream-K style decomposition comprises: rolling out iterations of the computational units to form a linear mapping;
dividing the total workload of all computational units into buckets demarcated such that each cooperative thread array has an equal amount of iterations to perform; and
assigning equal numbers of context length token iterations to each cooperative thread array, allowing for crossing of attention head and query boundaries.

5. The method of claim 1, wherein executing the attention operation for each computational unit in parallel comprises:
computing a local attention score matrix;
performing a local softmax operation on the local attention score matrix;
computing a partial attention output; and
storing local statistics including a local maximum and a local exponential sum for use in the reduction operation.

6. The method of claim 5, wherein each streaming multiprocessor of the plurality of multiprocessors is configured to:
process multiple computational units in sequence, wherein each computational unit comprises a different subset of tokens along the context length dimension;
maintain separate local statistics for each computational unit processed by that streaming multiprocessor, including separate local maximums and local exponential sums;
combine the partial attention outputs from the multiple computational units processed by that streaming multiprocessor before participating in the reduction operation; and
perform the reduction operation in a single fused kernel without launching additional reduction kernels.

7. The method of claim 5, wherein the reduction operation comprises:
processing the softmax re-scaling as an associative reduction operation;
combining the partial attention outputs from different computational units using the stored local statistics;
performing the reduction in a single fused kernel without launching additional reduction kernels; and
wherein the reduction operation is independent of problem size and scales efficiently for long context lengths.

8. The method of claim 1, wherein generating by the transformer-based language model an output further comprises:
receiving as input to the transformer-based language model a single token, representing a discrete unit of input data for a current step of a decode phase;
retrieving cached key-value tensors from previous tokens in the sequence of tokens;
generating, from the single token and the cached key-value tensors, input data for a subsequent attention operation, the input data including query, key, and value matrices, wherein the query matrix corresponds to the single token and the key and value matrices include the cached key-value tensors;
unequally partitioning the subsequent attention operation into a plurality of computational units for distributing to the plurality of multiprocessors of the GPU based on a total number of tokens in the cached key-value tensors, the number of attention heads in the transformer-based language model, the predetermined embedding size of a vector representation of a token, and the number of multiprocessors of the GPU, wherein each computational unit has a variable size and represents a subset of tokens from the cached key-value tensors along the context length dimension;
distributing the computational units across the multiprocessors of the GPU;
executing the subsequent attention operation for each computational unit in parallel, wherein each computational unit computes a partial attention output;
performing a reduction operation to combine the partial attention outputs from the computational units, wherein the reduction operation includes softmax re-scaling and accumulation;
generating a final attention output for the subsequent attention operation based on the combined partial attention outputs; and
generating, by the transformer-based language model, a next output token responsive to the single input token by processing the final attention output through subsequent layers of the transformer-based language model.

9. A system for increasing computational efficiency of an attention operation computation in a transformer-based language model, the system comprising:
a hardware processing unit having a plurality of multiprocessors; and a processor configured to:
receive as input to the transformer-based language model a sequence of tokens, each token representing a discrete unit of input data for the transformer-based language model;
generate, from the sequence of tokens, vector representations of each token, wherein each vector representation has a predetermined embedding size;
generate, from the vector representations of each token, input data for the attention operation, the input data including query, key, and value matrices;
unequally partition the attention operation into a plurality of computational units for distributing to the plurality of multiprocessors of the GPU based on a total number of tokens in the sequence of tokens, a number of attention heads in the transformer-based language model, the predetermined embedding size of a vector representation of a token, and the number of multiprocessors of the GPU, wherein each computational unit has a variable size and represents a subset of tokens from the sequence of tokens along a context length dimension;
distribute the computational units across the multiprocessors of the GPU;
execute the attention operation for each computational unit in parallel, wherein each computational unit computes a partial attention output;
perform a reduction operation to combine the partial attention outputs from the computational units, wherein the reduction operation includes softmax re-scaling and accumulation;
generate a final attention output for the attention operation based on the combined partial attention outputs; and
generate by the transformer-based language model an output, responsive to the input to the transformer-based language model, by processing the final attention output through subsequent layers of the transformer-based language model.

10. The system of claim 9, wherein unequally partitioning the attention operation into a plurality of computational units comprises:
determining a total workload based on the total number of tokens in the sequence of tokens, the number of attention heads in the transformer-based language model, and the predetermined embedding size of a vector representation of a token;
dividing the total workload by the number of multiprocessors of the GPU to determine an equal work allocation for each multiprocessor;
creating computational units of variable sizes, each representing a subset of tokens from the sequence of tokens along a context length dimension; and
assigning the computational units to the multiprocessors such that the sum of workloads for computational units assigned to each multiprocessor equals the determined equal work allocation.

11. The system of claim 9, wherein distributing the computational units across the multiprocessors of the GPU comprises using a stream-K style decomposition.

12. The system of claim 11, wherein the stream-K style decomposition comprises:
rolling out iterations of the computational units to form a linear mapping;
dividing the total workload into buckets demarcated such that each cooperative thread array has an equal amount of iterations to perform; and
assigning equal numbers of context length token iterations to each cooperative thread array, allowing for crossing of attention head and query boundaries.

13. The system of claim 8, wherein executing the attention operation for each computational unit in parallel comprises:
computing a local attention score matrix;
performing a local softmax operation on the local attention score matrix;
computing a partial attention output; and
storing local statistics including a local maximum and a local exponential sum for use in the reduction operation.

14. The system of claim 13, wherein each streaming multiprocessor of the plurality of multiprocessors is configured to:
process multiple computational units in sequence, wherein each computational unit comprises a different subset of tokens along the context length dimension;
compute local attention scores and perform local softmax operations for each computational unit;
maintain separate local statistics for each computational unit, including local maximums and local exponential sums; and
combine the partial attention outputs from the multiple computational units processed by that streaming multiprocessor before participating in the reduction operation.

15. The system of claim 13, wherein the reduction operation comprises:
treating the softmax re-scaling as an associative reduction operation;
combining the partial attention outputs from different computational units using the stored local statistics;
performing the reduction in a single fused kernel without launching additional reduction kernels; and
wherein the reduction operation is independent of problem size and scales efficiently for long context lengths.

16. The system of claim 9, wherein generating by the transformer-based language model an output further comprises:
receiving as input to the transformer-based language model a single token, representing a discrete unit of input data for a current step of a decode phase;
retrieving cached key-value tensors from previous tokens in the sequence of tokens;
generating, from the single token and the cached key-value tensors, input data for a subsequent attention operation, the input data including query, key, and value matrices, wherein the query matrix corresponds to the single token and the key and value matrices include the cached key-value tensors;
unequally partitioning the subsequent attention operation into a plurality of computational units for distributing to the plurality of multiprocessors of the GPU based on a total number of tokens in the cached key-value tensors, the number of attention heads in the transformer-based language model, the predetermined embedding size of a vector representation of a token, and the number of multiprocessors of the GPU, wherein each computational unit has a variable size and represents a subset of tokens from the cached key-value tensors along the context length dimension;
distributing the computational units across the multiprocessors of the GPU;
executing the subsequent attention operation for each computational unit in parallel, wherein each computational unit computes a partial attention output;
performing a reduction operation to combine the partial attention outputs from the computational units, wherein the reduction operation includes softmax re-scaling and accumulation;
generating a final attention output for the subsequent attention operation based on the combined partial attention outputs; and
generating, by the transformer-based language model, a next output token responsive to the single input token by processing the final attention output through subsequent layers of the transformer-based language model.

17. A non-transitory computer-readable storage medium storing instructions that, when executed by a processor, cause the processor to perform operations for increasing computational efficiency of an attention operation computation in a transformer-based language model executed on a hardware processing unit having a plurality of multiprocessors, the operations comprising:
receiving as input to the transformer-based language model a sequence of tokens, each token representing a discrete unit of input data for the transformer-based language model;
generating, from the sequence of tokens, vector representations of each token, wherein each vector representation has a predetermined embedding size;
generating, from the vector representations of each token, input data for the attention operation, the input data including query, key, and value matrices;
unequally partitioning the attention operation into a plurality of computational units for distributing to the plurality of multiprocessors of the GPU based on a total number of tokens in the sequence of tokens, a number of attention heads in the transformer-based language model, the predetermined embedding size of a vector representation of a token, and the number of multiprocessors of the GPU, wherein each computational unit has a variable size and represents a subset of tokens from the sequence of tokens along a context length dimension;
distributing the computational units across the multiprocessors of the GPU;
executing the attention operation for each computational unit in parallel, wherein each computational unit computes a partial attention output;
performing a reduction operation to combine the partial attention outputs from the computational units, wherein the reduction operation includes softmax re-scaling and accumulation;
generating a final attention output for the attention operation based on the combined partial attention outputs; and
generating by the transformer-based language model an output, responsive to the input to the transformer-based language model, by processing the final attention output through subsequent layers of the transformer-based language model.

18. The non-transitory computer-readable storage medium of claim 17, wherein unequally partitioning the attention operation into a plurality of computational units comprises:
determining a total workload based on the total number of tokens in the sequence of tokens, the number of attention heads in the transformer-based language model, and the predetermined embedding size of a vector representation of a token;
dividing the total workload by the number of multiprocessors of the GPU to determine an equal work allocation for each multiprocessor;
creating computational units of variable sizes, each representing a subset of tokens from the sequence of tokens along a context length dimension; and
assigning the computational units to the multiprocessors such that the sum of workloads for computational units assigned to each multiprocessor equals the determined equal work allocation.

19. The non-transitory computer-readable storage medium of claim 17, wherein distributing the computational units across the multiprocessors of the GPU comprises using a stream-K style decomposition.

20. The non-transitory computer-readable storage medium of claim 17, wherein the stream-K style decomposition comprises:
rolling out iterations of the computational units to form a linear mapping;
dividing the total workload into buckets demarcated such that each cooperative thread array has an equal amount of iterations to perform; and
assigning equal numbers of context length token iterations to each cooperative thread array, allowing for crossing of attention head and query boundaries.
